(19) United States
(12) Patent Application Publication
(10) Pub. No.: US 2019/0354541 A1
(43) Pub. Date: Nov. 21, 2019

(54) ENHANCED MECHANISMS FOR PREDICTIVE ESTIMATION IN AN ENTERPRISE ENVIRONMENT

(71) Applicant: Planisware SAS, Chatillon (FR)

(72) Inventors: Paul EVRARD, Fontenay aux Roses (FR); Pierre DEMONSANT, Paris (FR); Charles-Eric BOULANGÉ, Paris (FR); Damien NOZIÈRES, Mons en Baroeul (FR); Fabrice OLLIVIER, Paris (FR)

(73) Assignee: Planisware SAS, Chatillon (FR)

(21) Appl. No.: 16/414,732

(22) Filed: May 16, 2019

Related U.S. Application Data
(60) Provisional application No. 62/672,574, filed on May 16, 2018.

(51) Int. Cl. G06F 16/28; G06F 16/22; G06N 20/00

(52) U.S. Cl. CPC G06F 16/287; G06N 20/00; G06F 16/22

(57) ABSTRACT

Systems and methods for predictive estimation within an enterprise environment are provided. An enterprise environment is maintained with a plurality of clients and associated client data. The system generates one or more statistical models by analyzing the client data in the enterprise environment using one or more statistical algorithms, then stores the statistical models in a model database. The system receives a prediction estimate request from one of the plurality of clients with respect to the associated client data for the client. The system then selects, using a clustering algorithm, a subset of the associated client data, as well as best statistical model from the one or more statistical models based at least on the subset of the associated client data. The system then applies the statistical model to the subset of client data to generate prediction estimates and provides a visual arrangement of them to the client.

### CROSS-REFERENCE TO RELATED APPLICATIONS

This application claims the benefit of U.S. Provisional Application No. 62/672,574 (Attorney docket PLNWP003P), entitled “ENHANCED MECHANISMS FOR PREDICTIVE ESTIMATION IN AN ENTERPRISE ENVIRONMENT,” filed on May 16, 2018, which is incorporated by reference herein in its entirety for all purposes

### TECHNICAL FIELD

The present disclosure relates to enterprise environments, and specifically to predictive estimation in an enterprise environment.

### DESCRIPTION OF RELATED ART

Enterprise environments are increasingly becoming essential for businesses, developers, enterprise vendors, sales teams, and more. These environments provide a set of tools for enterprise teams to collaborate with others internally within the enterprise, and some also provide solutions for collaborating externally with customers, vendors, and others. A common use of enterprise environments is for project management, wherein the environment may include such features as tracking and modification of project development milestones, collaborative tools for document creation, time sheet reporting and tracking, task scheduling, and more. Many of these project management tools incorporate software as a service (or “SaaS”) technologies, which provide “on-demand” delivery of solutions in a cloud-based fashion, allowing for project management and customer environments accessible via browsers, as well as remote, convenient accessibility of project information and data wherever it is stored.

Some project management systems are moving from single-user/single-project management systems to complex, distributed, multi-functional systems that incorporate multidimensional data, and no longer cover project planning alone. Companies and organizations that have used project management tools and solutions for several years often have accumulated large amounts of data about past projects they have been working on. Such data can include planning data, cost data, information about how projects are organized, what the necessary research and development effort is, information about developed products, target customer profiles, and so on. Such clients have a need for predictive estimation of durations and expected finish times for projects and activities, and predictive estimation for many other aspects of project management, based on previous projects and historical project data.

Currently, a number of off-the-shelf solutions exist for predictive estimation and statistical modeling of predicted outcomes. For example, data analysis, statistical regression, and outliers detection all exist in various methods, processes, and algorithms. Such solutions can range from dedicated solutions, such as SAS software by SAS Institute, Inc., to more general ones, such as Matlab by The MathWorks, Inc., which can offer toolboxes dedicated to data mining and analysis as well as open source libraries, such as Python's scikit-learn library.

However, using such solutions with project management data in an enterprise environment requires a few aspects to be present. First, interfaces must be developed between the data mining software and the project management environment or other specific development to integrate the data mining library into the project management environment, when the license allows it. Second, domain-specific knowledge is required about the data available in the project management software (for example, what the relevant data is and how to retrieve it, in which format it is provided in, and if and how it must be transformed before processing it). This must be combined with knowledge about the existing algorithms, including their strengths and weaknesses, their parameters, the data preprocessing they may require and how to interpret the results. Typically, human specialists must be present and deployed to manually select the algorithm and input driver, and human statisticians must determine an appropriate model that can perform predictions for a particular situation.

In addition, with complex project management software containing potentially thousands of clients with thousands of projects, activities for those projects, characteristics for those activities, activity types, and so on, along with procedures associated with them, the challenge of providing an appropriate model for performing predictions is a complex one that requires a great deal of preparation and work. Each characteristic can have many different value ranges. When all of these characteristics are accumulated, there are many dimensions of data present. Often, the off-the-shelf solutions and algorithms will not fit the data, and thus the data will have to be cleaned and only a few characteristics will be selected in a specific, limited way.

An attempt to provide a solution to this is an estimation by analogy approach, wherein each data point is compared to similar data points with respect to criteria that has been manually set. The main limitation is that specifying the similarity criteria is cumbersome and requires business knowledge, and it must be done at runtime for each prediction. Further, this approach does not highlight outlying data points.

Consequently, it is desirable in an enterprise environment or project management system to provide enhanced mechanisms for predictive estimation that overcome some of the drawbacks of conventional systems.

### OVERVIEW

Systems, methods, and devices provided herein provide for predictive estimation within an enterprise environment. An enterprise environment is maintained with a plurality of clients and a plurality of associated client data. The system generates one or more statistical models by analyzing the client data in the enterprise environment using one or more statistical algorithms, then stores the statistical models in a model database. The system receives a prediction estimate request from one of the plurality of clients with respect to the associated client data for the client. The system then selects, using a clustering algorithm, a subset of the associated client data based at least on one or more characteristics of the associated client data. The system selects, using machine learning techniques, a statistical model from the one or more statistical models based at least on the subset of the associated client data and the one or more characteristics. The system then applies the statistical model to the subset of client data to generate prediction estimates and statistical outliers, and provides a visual arrangement of them to the client.

### BRIEF DESCRIPTION OF THE DRAWINGS

The disclosure may best be understood by reference to the following description taken in conjunction with the accompanying drawings, which illustrate particular embodiments of the present invention.

FIG. 1 shows a system diagram of an example of a system 100 for predictive estimation within an enterprise environment, in accordance with some implementations.

FIG. 2 illustrates one example 200 of a flow process diagram for predictive estimation in an enterprise environment.

FIG. 3 shows an example of predictive estimation on client data in the enterprise environment.

FIG. 4 shows an example of a statistical model applied to client data in the enterprise environment.

FIG. 5 shows an example of a statistical outlier for client data in the enterprise environment.

FIG. 6 shows an example of a model definition in the enterprise environment.

FIG. 7 illustrates one example of a computer system.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of enterprise environments and project management environments, including providing predictive estimation in such environments. However, it should be noted that the techniques of the present invention apply to a wide variety of different enterprise environments, collaborative environments, data structures, predictive estimation tools, and different types of data. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Companies and organizations that have used project management software solutions for several years often have lots data about past projects they have been working on. Such data can include planning data, cost data, information about how projects are organized, what the necessary research and development effort is, information about the developed products, the target customer profiles, and so on. Systems, methods, and devices provided herein provide for a statistical machine learning system that aims at taking advantage of this data by extracting information from it and presenting this information in the project management environment itself.

In some embodiments, the system can be used for data analysis. Available client data within a project management environment is not necessarily “clean”, i.e., sometimes user input is erroneously entered in the system or not entered at all; sometimes the organization of the company changes and the data structure changes starting from a given date; sometimes part of the data is simply not relevant and it is not expected that information can be extracted from it. The system automatically identifies subsets of data where information can be extracted and highlights it in a clear and understandable way to the user in a visual arrangement, such as graphs, charts, or other visual ways of representing information.

In some embodiments, the system can be used for statistical regression. Given a set of input values, the system can predict an outcome value based on existing similar data. For instance, the system can predict the cost of a project given the product category, the customer target, the market size and the required R&D effort; this is typically a statistical regression setup.

In some embodiments, the system can be used for outliers detection. In a given subset of data where a relationship has been extracted between a specified outcome measure (e.g. project cost) and input drivers (research and development, i.e. “R&D” effort, product type, target customer, etc.), some points can behave differently. For instance, the cost of a few projects might have escalated because the R&D effort was not properly appreciated, the project scope has changed, or input errors exist in the project data. Such instances are highlighted so that the user can spot them quickly and investigate the root causes of the observed deviation.

In some embodiments, the statistical learning and predictive estimation system is fully integrated to the project management (“PPM”) environment. To avoid consuming computation time transforming data from one format to an other, and to fully benefit from all data and meta-data available in the environment, most algorithms exist at the core of the system. This gives room for any customization of existing algorithms to fit the specificities of the enterprise environment. For instance, in some embodiments the system uses Gradient Boosted Trees as an algorithm. Off-the-shelf implementations do not allow for making use of some specific aspects of the enterprise environment data, for example when portions of categorical variables have a tree semantics, wherein there is a parenthood relationship between values. Such variables are typically used to represent breakdown structures such as resources, organization, activity types and so on. The system utilizes this tree structure to avoid selecting variables that would otherwise be artificially selected by the off-the-shelf implementation due to an intrinsic limitation of the algorithm, unless by using very fine-tuned parameter values (at a level that is not possible with all available implementations).

In some embodiments, the system takes into account knowledge about the available data from which a user or company might want to extract information. Not all available data in the environment is necessarily relevant. For off-the-shelf algorithms to work properly, it is necessary to remove irrelevant data points from the data. The user running the algorithm must know how to identify the subsets of interest and run the algorithms on these subsets. In addition, all characteristics of the data are not relevant. The cost of a project does not necessarily depend on all the information about the project that has been entered in the system. When feeding algorithms with rich data (e.g. trying to predict project cost using all project characteristics without explicitly ignoring irrelevant input fields such as “project internal identifier”, or “project description”), many data points are needed to avoid over-fitting the data, or extracting relationships that allow fitting the data but have no meaning from an enterprise perspective, such as trying to predict the cost of a project using its internal identifier. In some embodiments, the system handles this problem by taking advantage of meta-data: it not only uses the data points themselves, but also knowledge about the characteristics themselves. In some embodiments, an input variable is not just either “numeric” or “categorical”, like in most existing algorithms, but rather “text data with free user input” (such characteristics should in general be eliminated because there are too many possible values for a significant relationship with an outcome value to be extracted), “data with restricted user input” (the user chooses a value among a list of possible values), “data with a tree structure” (so a distance between two different values can be computed), “numeric data compute from other input data” (therefore it is likely to be correlated to other input data), and so on. In some embodiments, the system also understands whether an input field has been filled or not, and whether the available value is the default value or not (for numeric and categorical values).

In some embodiments, the system makes use of metadata to reduce the number of input dimensions of the datasets fed to the algorithms and to split the data into different subsets to separate good-quality data from noisy data, therefore addressing the problem of required knowledge about the data. The system uses the knowledge about whether values have been provided or not for an input field as well as the tree-structured input fields to create clusters of similar data (with respect to a set of tree-structured input fields and to a subset of potential input drivers). The idea is to replace a set of data with many input dimensions with subsets of data with fewer input dimensions, and then to run regression algorithms on the resulting subsets. The reduced input dimension allows the algorithms to perform better; when all algorithms have run a map, graph, chart, or visual arrangement of the data quality can be presented to the user, where good-quality data is clearly visible.

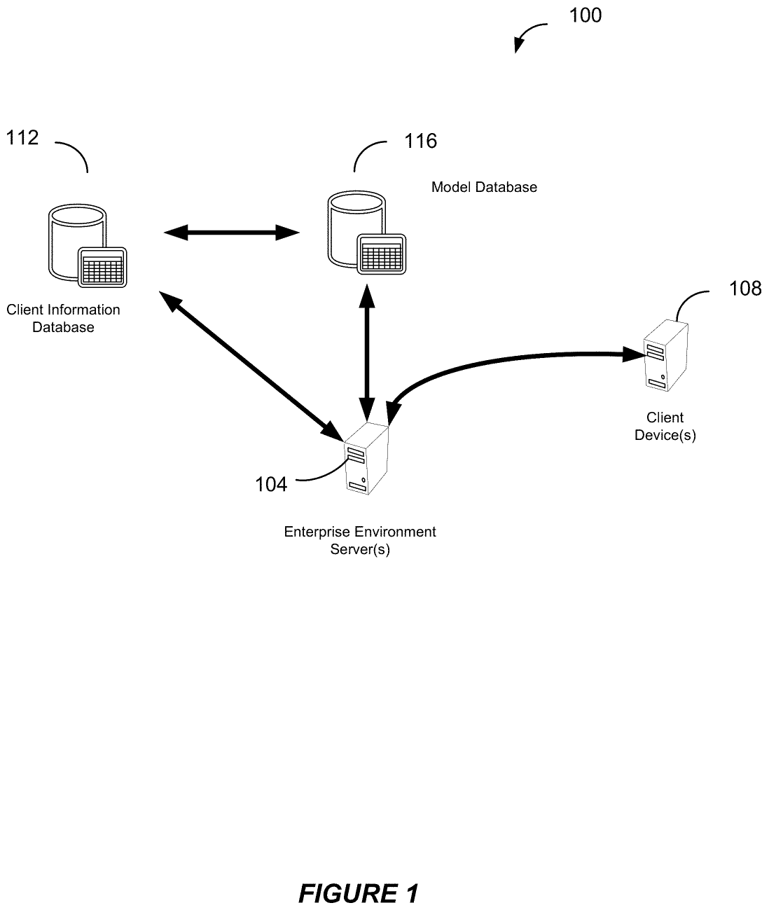

FIG. 1 shows a system diagram of an example of a system 100 for exchanging information within an enterprise environment, in accordance with some implementations. System 100 includes a variety of different hardware and/or software components which are in communication with each other. In the non-limiting example of FIG. 1, system 100 includes at least one enterprise environment server 104, at least one client device 108, client information database 112, and a model database 116.

The enterprise environment server 104 may communicate with other components of system 100. This communication may be facilitated through a combination of networks and interfaces. Enterprise environment server 104 may handle and process data requests and data transfers from the client device 108 and the partner device 110. Likewise, enterprise environment server 104 may return a response to client device 108 after a data request has been processed. For example, enterprise environment server 104 may retrieve data from one or more databases, such as the client information database 112 or the partner updates database 116. It may combine some or all of the data from different databases, and send the processed data to one or more client devices or partner devices.

A client device 108 may be a computing device capable of communicating via one or more data networks with a server. Examples of client device 108 include a desktop computer or portable electronic device such as a smartphone, a tablet, a laptop, a wearable device, an optical head-mounted display (OHMD) device, a smart watch, etc. Client device 108 includes at least one browser in which applications may be deployed.

Client information database 112 can be a database implemented in a relational or non-relational database management system. In some embodiments, this database can include the contents of one or more client-related databases within the enterprise environment. Examples of data that can be stored within the client information database 112 in various embodiments are client information, partner information, project information, activity information, task information, billing report information, project roadmap information, and so on.

Model database 116 can be a database implemented in a relational or non-relational database management system. In some embodiments, this database can include statistical models generated from all or a subset of the client data in the enterprise environment. These models can later be selected to find the best statistical model for a given set of data, using machine learning techniques.

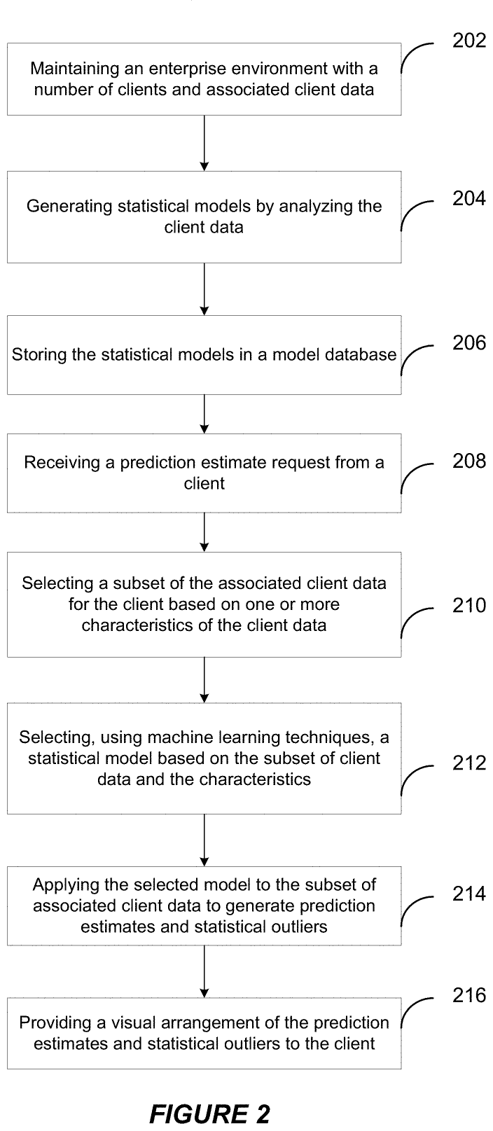

FIG. 2 illustrates one example 200 of a flow process diagram for predictive estimate in an enterprise environment. As discussed above, various components of system 100 may be configured to implement the information exchange.

At block 202, an enterprise environment is maintained with a plurality of clients and a plurality of associated client data. At block 204, the system generates one or more statistical models by analyzing the client data in the enterprise environment using one or more statistical algorithms. At block 206, the system stores the statistical models in a model database. At block 208, the system receives a prediction estimate request from one of the plurality of clients with respect to the associated client data for the client. At block 210, the system then selects, using a clustering algorithm, a subset of the associated client data based at least on one or more characteristics of the associated client data. At block 212, the system selects, using machine learning techniques, a statistical model from the one or more statistical models based at least on the subset of the associated client data and the one or more characteristics. At block 214, the system then applies the statistical model to the subset of client data to generate prediction estimates and statistical outliers. At block 216, the system provides a visual arrangement of the prediction estimates and statistical outliers to the client.

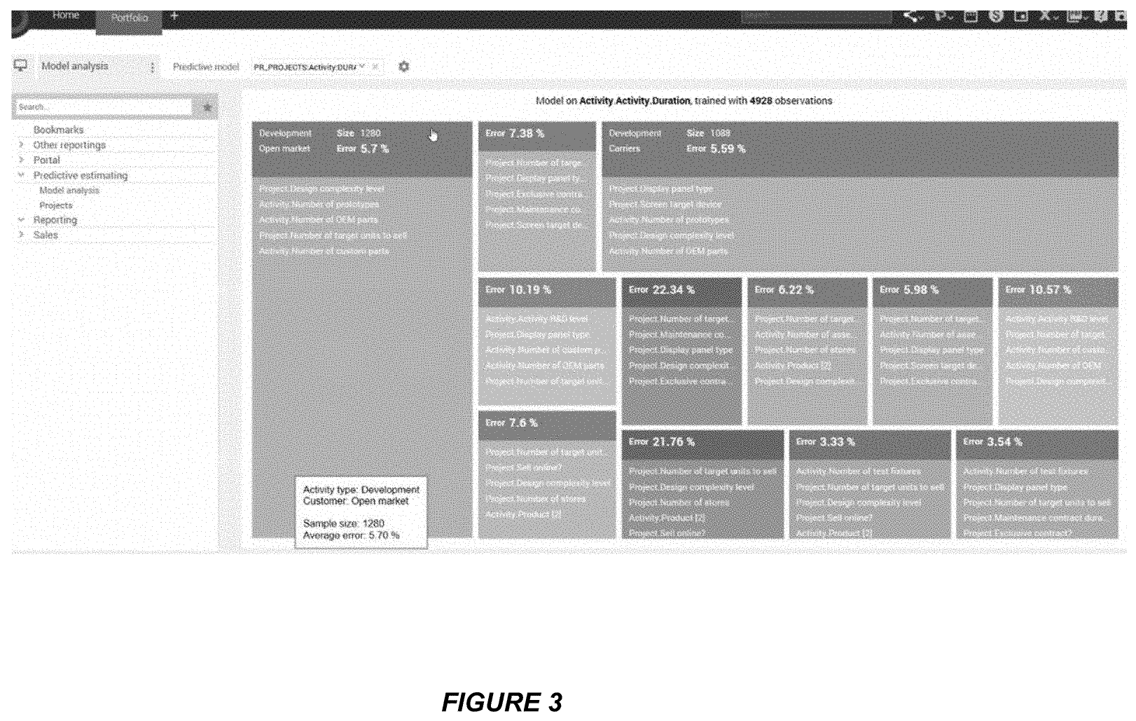

FIG. 3 illustrates an example of predictive estimation on client data in the enterprise environment, presented in a visual arrangement to make statistical outliers clear. In some embodiments, a model quality map is provided after the statistical analysis is performed on the subset of associated client data. The worst models, according to a cross-validated error value, are shown in red boxes; the best models are shown in green. Yellowish boxes are in-between in terms of quality. The size of the boxes represents the size of the subset of data used to train the models. A banner shows the tree-structured input values that have been used to produce the clusters and the cross-validated error. A list of the most important input drivers used by the models is shown below the banner, inside each box.

In some embodiments, the visual arrangement provides the user or company with insight about the data and also allows a quality flag to be set to existing data and future predictions, depending on the cluster the observation falls in.

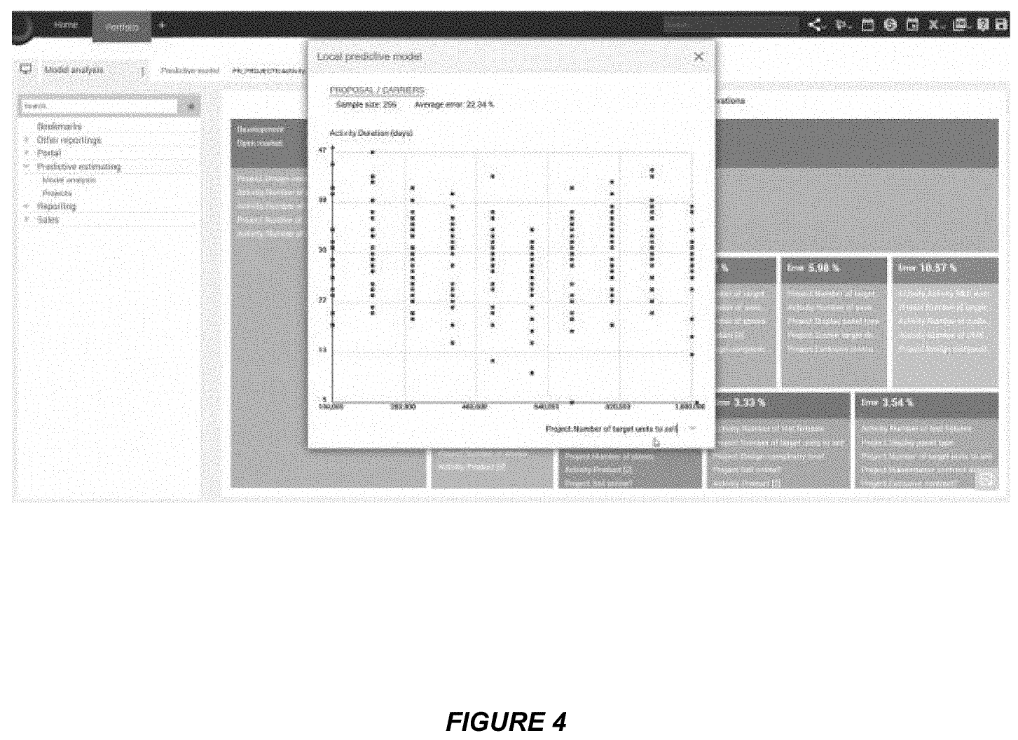

FIG. 4 shows an example of a statistical model applied to client data in the enterprise environment, particularly a local predictive model. The user can see a list of all activities (by project) where a relationship is supposed to exist between their cost and the input drivers but where the predicted value differs significantly from the cost entered in the system.

In some embodiments, splitting the data also allows to run different algorithms for different packs of data, with different parameters, therefore hiding the complexity of algorithm selection and parameter tuning to the user. In some embodiments, for large subsets of data where complex relationships can be expected, flexible and robust models such as Gradient Boosted Trees (GBT) can be used. When fewer observations are available (the available data is less dense), linear models can provide good results, are less subject to overfitting and are more compact (they require less storage space). In some embodiments, for very small data packs or very consistent ones, a centroid (the arithmetic mean or a median of the outcome values) can be used, which is really fast to compute and requires very little storage space. Based on the size of a subset of data, such as number of points and input dimensions, the system attempts a subset of algorithms (e.g. it makes no sense to try GBT on a set of ten points with several input dimensions), then uses cross-validation to select the most appropriate model with the best parameters.

In some embodiments, when the data has been clustered, the algorithms and parameters have been selected and the models have been trained, the system can associate a predicted value of the outcome for all data points as well as a quality flags and the subset of input fields that are mostly used to produce the predictions. The system is then able to easily highlight large prediction errors associated to good-quality models so that the user can easily spot potential outliers (which can be due to various reasons including errors when entering data into the system, cost escalations, domain-specific bias, . . . ). The possibility to highlight fewer and more relevant outliers comes from the fact that the system will look for them only in the subsets of data where a good-quality model has been trained. Moreover these outliers are defined with respect to a domain-specific relationship (it is not just a data point that is very different from other points, it is a data point for that behaves differently from similar data points in terms of the identified relationship between the outcome and the identified important inputs). This results from the system's approach to reduce data dimensionality and separate good-quality subsets of data from noisy data.

In some embodiments, the data analysis process within the system utilizes a clustering component. This component uses meta data about input values to produce subsets of data. It relies on an implementation of the k-means clustering algorithm. In some embodiments, the model and parameter selection component uses heuristics based on the number of data points and the input size to select candidates models and parameter values, as well as data preprocessing algorithms. In some embodiments, it then selects the best model and parameter values using Cross-Validation. In some embodiments, the Gradient Boosted Trees algorithm (GBT) has been customized to take meta data into account and overcome some of the weaknesses of the algorithm.

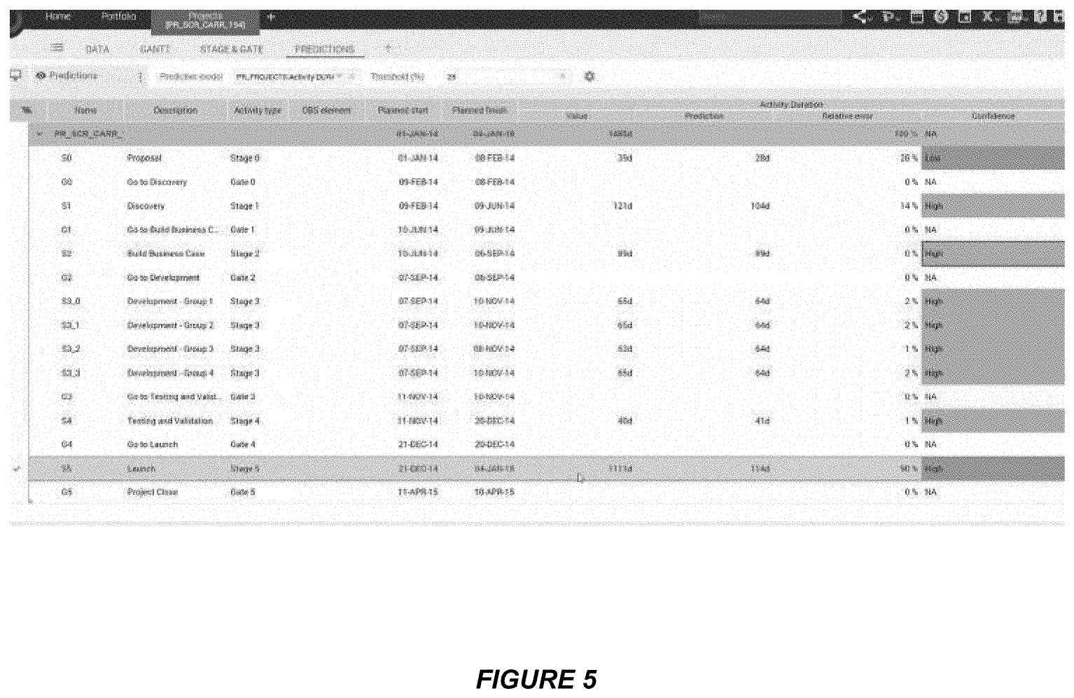

FIG. 5 shows an example of a statistical outlier for client data in the enterprise environment. In this example, a project is shown with a large prediction error. The right column indicates the prediction confidence, directly related to the quality of the model used to perform the prediction. Since the prediction is for 114 days but the value is for 1,111 days, it is flagged as a statistical outlier.

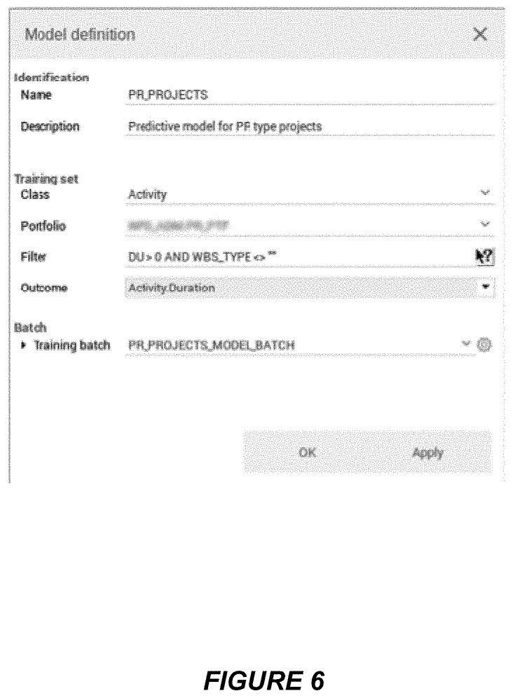

FIG. 6 shows an example of a model definition in the enterprise environment. In some embodiments, a user will train a model on a portfolio of projects containing all projects of the last decade, and will specify that the model has to find a relationship between the duration of the project activities versus input fields on the activities and their projects.

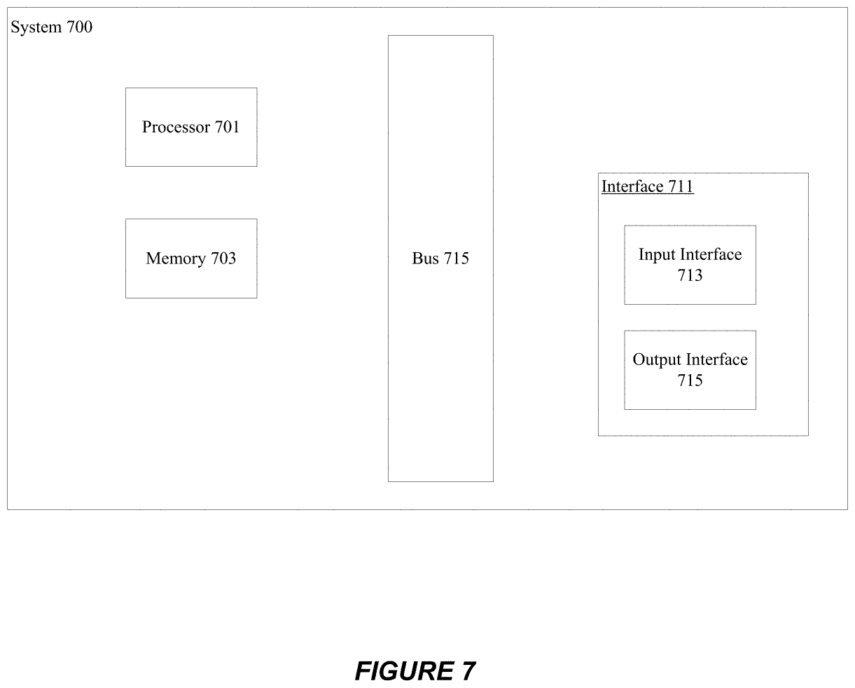

Various computing devices can implement the methods described. For instance, a mobile device, computer system, etc. can be used for accessing aspects of the enterprise environment by either the client or the partner, or both. With reference to FIG. 7, shown is a particular example of a computer system that can be used to implement particular examples of the present invention. For instance, the computer system 700 can be used to provide generate artificially rendered images according to various embodiments described above. In addition, the computer system 700 shown can represent a computing system on a mobile device. According to particular example embodiments, a system 700 suitable for implementing particular embodiments of the present invention includes a processor 701, a memory 703, an interface 711, and a bus 715 (e.g., a PCI bus). The interface 711 may include separate input interface 713 and output interface 715, or may be a unified interface supporting both operations. When acting under the control of appropriate software or firmware, the processor 701 is responsible for such tasks such as optimization. Various specially configured devices can also be used in place of a processor 701 or in addition to processor 701. The complete implementation can also be done in custom hardware. The interface 711 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 700 uses memory 703 to store data and program instructions and maintain a local side cache. The program instructions may control the operation of an operating system and/or one or more applications, for example. The memory or memories may also be configured to store received metadata and batch requested metadata.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present disclosure.

While the present disclosure has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
maintaining an enterprise environment comprising a plurality of clients and a plurality of associated client data;
generating one or more statistical models by analyzing the client data in the enterprise environment using one or more statistical algorithms;
storing the statistical models in a model database;
receiving a prediction estimate request from one of the plurality of clients with respect to the associated client data for the client;
selecting, using a clustering algorithm, a subset of the associated client data based at least on one or more characteristics of the associated client data;
selecting, using machine learning techniques, a statistical model from the one or more statistical models based at least on the subset of the associated client data and the one or more characteristics;
applying the selected statistical model to the subset of the associated client data and the one or more selected characteristics to generate one or more prediction estimates and one or more statistical outliers; and
providing a visual arrangement of the one or more prediction estimates and one or more statistical outliers to the client.

2. The method of claim 1, wherein the one or more statistical models comprise at least one of gradient boosted trees, linear models, and centroids.

3. The method of claim 1, wherein selecting the statistical model includes using cross-validation.

4. The method of claim 1, wherein input into statistical models includes data and metadata.

5. The method of claim 1, wherein the one or more predictions include a predicted value of the outcome of the subset of associated client data, a quality flag, and a subset of input fields to produce the one or more predictions.

6. The method of claim 1, wherein meta-data is used to reduce the number of input dimensions of the associated client data.

7. The method of claim 1, wherein a plurality of one or more statistical algorithms are implemented at a core level of software.

8. A system comprising:
a processor; and
memory, the memory storing program instructions to execute a method, the method comprising:
maintaining an enterprise environment comprising a plurality of clients and a plurality of associated client data;
generating one or more statistical models by analyzing the client data in the enterprise environment using one or more statistical algorithms;
storing the statistical models in a model database;
receiving a prediction estimate request from one of the plurality of clients with respect to the associated client data for the client;
selecting, using a clustering algorithm, a subset of the associated client data based at least on one or more characteristics of the associated client data;
selecting, using machine learning techniques, a statistical model from the one or more statistical models based at least on the subset of the associated client data and the one or more characteristics;
applying the selected statistical model to the subset of the associated client data and the one or more selected characteristics to generate one or more prediction estimates and one or more statistical outliers; and
providing a visual arrangement of the one or more prediction estimates and one or more statistical outliers to the client.

9. The system of claim 8, wherein the one or more statistical models comprise at least one of gradient boosted trees, linear models, and centroids.

10. The system of claim 8, wherein selecting the statistical model includes using cross-validation.

11. The system of claim 8, wherein input into statistical models includes data and metadata.

12. The system of claim 8, wherein the one or more predictions include a predicted value of the outcome of the subset of associated client data, a quality flag, and a subset of input fields to produce the one or more predictions.

13. The system of claim 8, wherein meta-data is used to reduce the number of input dimensions of the associated client data.

14. The system of claim 8, wherein a plurality of one or more statistical algorithms are implemented at a core level of software.

15. A non-transitory computer readable medium storing instructions to execute a method, the method comprising:
maintaining an enterprise environment comprising a plurality of clients and a plurality of associated client data;
generating one or more statistical models by analyzing the client data in the enterprise environment using one or more statistical algorithms;
storing the statistical models in a model database;
receiving a prediction estimate request from one of the plurality of clients with respect to the associated client data for the client;
selecting, using a clustering algorithm, a subset of the associated client data based at least on one or more characteristics of the associated client data;
selecting, using machine learning techniques, a statistical model from the one or more statistical models based at least on the subset of the associated client data and the one or more characteristics;
applying the selected statistical model to the subset of the associated client data and the one or more selected characteristics to generate one or more prediction estimates and one or more statistical outliers; and
providing a visual arrangement of the one or more prediction estimates and one or more statistical outliers to the client.

16. The non-transitory computer readable medium of claim 15, wherein the one or more statistical models comprise at least one of gradient boosted trees, linear models, and centroids.

17. The non-transitory computer readable medium of claim 15, wherein selecting the statistical model includes using cross-validation.

18. The non-transitory computer readable medium of claim 15, wherein input into statistical models includes data and metadata.

19. The non-transitory computer readable medium of claim 15, wherein the one or more predictions include a predicted value of the outcome of the subset of associated client data, a quality flag, and a subset of input fields to produce the one or more predictions.

20. The non-transitory computer readable medium of claim 15, wherein meta-data is used to reduce the number of input dimensions of the associated client data.
